(19) United States
(12) Patent Application Publication
(10) Pub. No.: US 2009/0097159 A1
(43) Pub. Date: Apr. 16, 2009

(54) PERPENDICULAR MAGNETIC RECORDING HEAD AND MANUFACTURING METHOD THEREFOR

(75) Inventors: Mitsuru Otagiri, Kawasaki (JP); Hiroshi Shirataki, Kawasaki (JP); Yuko Miyake, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/236,329

(22) Filed: Sep. 23, 2008

(30) Foreign Application Priority Data
Oct. 16, 2007 (JP) 2007-268611

(51) Int. Cl. G11B 5/127; B05D 3/12

(52) U.S. Cl. 360/125.3; 427/129; G9B/5.04

(57) ABSTRACT

A manufacturing method for a perpendicular magnetic recording head includes the steps of forming a groove in a first nonmagnetic layer, forming a side shield, forming a second nonmagnetic layer, forming a main-magnetic-pole front end portion and forming a main-magnetic-pole yoke portion. The groove extends in a front-rear direction orthogonal to an air bearing surface. The side shield of soft magnetic material, the second nonmagnetic layer and the main-magnetic-pole front end portion of soft magnetic material are formed on an inner wall of the groove. The main-magnetic-pole front end portion is not magnetostatically coupled to the side shield. The main-magnetic-pole yoke portion magnetically is insulated from the side shield and magnetically connected to the main-magnetic-pole front end portion. The main-magnetic-pole yoke portion widens from the main-magnetic-pole front end portion toward a rear side.

### CROSS-REFERENCE TO RELATED APPLICATION

This application is based upon and claims the benefit of priority of the prior Japanese Patent Application No. 2007-268611, filed on Oct. 16, 2007, the entire contents of which are incorporated herein by reference.

### BACKGROUND

1. Field

An aspect of the invention is related to a perpendicular magnetic recording head in which a side shield is provided on either side of a front end portion of a main magnetic pole, and to a manufacturing method for the perpendicular magnetic recording head.

2. Description of the Related Art

FIG. 5 illustrates a thin film magnetic head for perpendicular magnetic recording. FIG. 5 is a cross-sectional view, taken along a cross section of the thin film magnetic head orthogonal to an air bearing surface at the center in the core width direction.

The thin film magnetic head shown in FIG. 5 includes a perpendicular magnetic recording head for recording magnetic information on a recording layer, and a read head for reading magnetic information recorded on a magnetic recording medium. The perpendicular magnetic recording head records magnetic information by magnetizing a recording layer of a magnetic recording medium (not shown), such as a magnetic disk, in a predetermined magnetization pattern. The read head includes a lower shield layer 20, an upper shield layer 30, and a read element 82. The perpendicular magnetic recording head includes a main magnetic pole 80, a first return yoke 88, a second return yoke 96, a back gap 92, a trailing shield 94, and coils 36a and 36b. In FIG. 5, spaces between the layers are filled with a nonmagnetic material such as alumina.

FIG. 6 is an explanatory view showing the planar shape of the main magnetic pole 80 (magnetic pole) in the thin film magnetic head for perpendicular magnetic recording, as viewed from above in the laminating direction. As shown in FIG. 6, the main magnetic pole 80 of the thin film magnetic head for perpendicular magnetic recording includes a front end portion 80a and a yoke portion 80b. The front end portion 80a is shaped like a neck having a small and constant core width, and is provided on an air bearing surface 48 side. The yoke portion 80b gradually widens from the front end portion 80a toward the rear side. In a magnetic storage apparatus such as a hard disk drive, an end face of the front end portion 80a exposed to the air bearing surface 48 is provided to face a magnetic recording medium such as a magnetic disk. Using a magnetic field produced from the end face, magnetic information is recorded on a recording layer of the magnetic recording medium. In this application, a side of the thin film magnetic head close to the magnetic recording medium (close to the air bearing surface) is referred to as a “front side”, and a side of the thin film magnetic head remote from the magnetic recording medium (remote from the air bearing surface) is referred to as a “rear side”. Further, a “front-rear direction” refers to a direction orthogonal to the surface of the magnetic recording medium (air bearing surface).

The outline of a manufacturing method for a thin film magnetic head for perpendicular magnetic recording will now be described with reference to FIG. 5 serving as a cross-sectional view of the thin film magnetic head. First, the lower shield layer 20 of a read head is formed on a wafer substrate (not shown) by wet plating. Then, the lower shield layer 20 is flattened by polishing a surface thereof. Subsequently, the read element 82, which is a TMR element or a CPP-GMR element, is formed on the lower shield layer 20. Then, hard bias films (not shown) are formed on either side of the read element 82 (on the front and back sides of the plane of FIG. 5). On the rear side of the read element 82, the nonmagnetic layer 26 is formed. Next, the upper shield layer 30 is formed on the read element 82, the nonmagnetic layer 26, and the hard bias films. Then, the nonmagnetic layer 32 is formed on the upper shield layer 30.

Further, the first return yoke 88 of the perpendicular magnetic recording head is formed on the nonmagnetic layer 32. Subsequently, the nonmagnetic layer 33 is formed on the first return yoke 88, and the first coil 36a is formed on the nonmagnetic layer 33. Then, the nonmagnetic layer 41 is sputtered on the entire surfaces of the nonmagnetic layer 33 and the first coil 36a, and a surface of the nonmagnetic layer 41 is flattened by polishing. Next, the nonmagnetic layer 39 is sputtered on the first coil 36a.

Subsequently, the main magnetic pole 80 is formed on the nonmagnetic layer 39. After formation of the main magnetic pole 80, the back gap 92 is stacked on a rear end of the main magnetic pole 80, and a nonmagnetic layer is formed on the main magnetic pole 80. Then, the second coil 36b is formed on the nonmagnetic layer so as to surround the back gap 92. The trailing shield 94 is formed above and at a distance from a front end of the main magnetic pole 80. A nonmagnetic layer is formed on the second coil 36b, and the return yoke 96 is formed on the nonmagnetic layer so as to be connected to the back gap 92 and the trailing shield 94. Further, a protective layer (not shown) is stacked on the return yoke 96, and a process of, for example, forming external connection terminals, is performed. As a result, a layered structure of a slider is completed on the wafer substrate.

Various methods for forming a main magnetic pole are known. Japanese Laid-Open Patent Publication No. 2006-196142 teaches a method for manufacturing a thin film magnetic head for perpendicular magnetic recording by using a so-called Damascene process. FIGS. 7A to 7E explain the first half of a procedure for forming a front end portion of a main magnetic pole taught in Japanese Laid-Open Patent Publication No. 2006-196142. FIGS. 7A to 7E are cross-sectional views of the front end portion of the main magnetic pole, as viewed from the side of an air bearing surface.

As shown in FIG. 7A, first, a resist pattern 100 is formed on an intermediate nonmagnetic layer 532 (corresponding to the nonmagnetic layer 39 in FIG. 5), and a tantalum film serving as an underlayer 101 is formed on the resist pattern 100, for example, by sputtering.

Next, as shown in FIG. 7B, an alloy film 102 serving as a first main-magnetic-pole soft magnetic layer 5400 is formed on the underlayer 101. Further, an alloy film 103 serving as a second main-magnetic-pole soft magnetic layer 5401 is formed on the alloy film 102.

Further, as shown in FIG. 7C, an alloy film 104 serving as a main-magnetic-pole soft magnetic center layer 5402 is formed on the alloy film 103, for example, by plating. In this case, the alloy film 104 is formed so that at least the entire trapezoidal area serving as a main magnetic pole layer is filled with the alloy film 104.

Subsequently, as shown in FIG. 7D, an end face 105 is formed by chemical mechanical polishing (CMP) and/or ion milling so that first and second main-magnetic-pole soft magnetic layers 5400 and 5401 and a main-magnetic-pole soft magnetic center layer 5402 are exposed therefrom. The main-magnetic-pole soft magnetic center layer 5402 is provided in the center. Then, as shown in FIG. 7E, the resist pattern 100 is removed. Through the above-described steps, a laminated body 106 serving as a main magnetic pole layer 540 (FIG. 8C) is barely formed on the intermediate nonmagnetic layer 532 (FIG. 7A).

FIGS. 8A to 8C show the second half of the procedure for forming the main magnetic pole. As shown in FIG. 8A, a first covering film 110 serving as an upper nonmagnetic layer 533 is formed on the laminated body 106 serving as the main magnetic layer 540 and the intermediate nonmagnetic layer 532, for example, by sputtering. The first covering film 110 is formed of, for example, alumina. Then, a stop film 111 of a material having a low CMP polishing rate, such as tantalum, is formed by, for example, sputtering and photolithography. The stop film 111 is provided at a position near the laminated body 106 and closer to an upper surface of the intermediate nonmagnetic layer 532 than the end face 105 of the laminated body 106.

Subsequently, as shown in FIG. 8B, a second covering film 112 is, for example, formed of alumina on the first covering film 110 and the stop film 111 by sputtering. Then, as shown in FIG. 8C, CMP is performed to reach the stop film 111, thereby forming an end face 540b facing an auxiliary magnetic layer. The end face 540b is flush with polished surfaces of the first and second covering films 110 and 112. Consequently, a main magnetic pole layer 540 (corresponding to the main magnetic pole 80 in FIG. 5) and an upper nonmagnetic layer 533 (corresponding to the nonmagnetic layer 39 in FIG. 5) are completed.

In order to meet a demand to increase the recording density in the perpendicular magnetic recording method, it is necessary to reduce the pitch of tracks on a magnetic recording medium (magnetic disk) (reduction in track width). With reduction in track width, side track erasing resulting from a magnetic field leaking from the main magnetic pole in the lateral direction (core width direction, a direction crossing the track) is becoming a problem.

In order to solve the problem of side track erasing, it is proposed to provide a side shield at each side of a front end portion of a main magnetic pole. Japanese Laid-Open Patent Publication Nos. 2005-190518 and 2004-127480 disclose perpendicular magnetic recording heads in which a side shield is provided in a front end portion of a main magnetic pole.

In particular, Japanese Laid-Open Patent Publication No. 2005-190518 teaches a method for forming a side shield. FIGS. 9A to 9F are cross-sectional views of a known side shield, as viewed from an air bearing surface, and FIGS. 10A to 10F are cross-sectional views of the known side shield, as viewed from the direction perpendicular to an air bearing surface.

FIG. 9A and FIG. 10A show a state in which a main magnetic pole 11 is formed on a nonmagnetic layer. Next, as shown in FIG. 9B and FIG. 10B, an alumina film 21 is formed on the main magnetic pole 11 by sputtering. Then, as shown in FIG. 9C and FIG. 10C, the alumina film 21 is etched by ion milling, thereby forming a gap film 22.

After an underlayer (not shown) for plating is formed, a resist pattern 23 is formed, as shown in FIG. 9D and FIG. 10D. By using the plating underlayer and the resist pattern 23 formed in FIG. 9D and FIG. 10D, a magnetic film serving as a trailing side shield 13 is formed by plating, as shown in FIG. 9E and FIG. 10E. Then, as shown in FIG. 9F and FIG. 10F, the resist pattern 23, the plating underlayer and unnecessary portions of the plated magnetic film are removed, so that a trailing side shield 13 is formed on the gap film 22 which is formed on the main magnetic pole 11. In the final step of forming the head, the trailing side shield 13 is processed to a desired thickness Gd by processing the air bearing surface.

However, in the side-shield forming method taught in Japanese Laid-Open Patent Publication No. 2005-190518, the side shield is formed after the main magnetic pole is formed. Therefore, it is necessary to perform many steps (FIGS. 9B to 9F and FIGS. 10B to 10F). This complicates the procedure and raises the level of technical difficulty.

### SUMMARY

In accordance with an aspect of an embodiment, a manufacturing method for a perpendicular magnetic recording head includes the steps of forming a groove in a first nonmagnetic layer, forming a side shield, forming a second nonmagnetic layer, forming a main-magnetic-pole front end portion and forming a main-magnetic-pole yoke portion. The groove extends in a front-rear direction orthogonal to an air bearing surface. The side shield is formed on an inner wall of the groove. The side shield is formed of a soft magnetic material. The second nonmagnetic layer is formed on a surface of the side shield in the groove. The main-magnetic-pole front end portion is formed on a surface of the second nonmagnetic layer in the groove. The main-magnetic-pole front end portion is formed of a soft magnetic material that is not magnetostatically coupled to the side shield. The main-magnetic-pole yoke portion magnetically is insulated from the side shield and magnetically connected to the main-magnetic-pole front end portion. The main-magnetic-pole yoke portion widens from the main-magnetic-pole front end portion toward a rear side.

It is an object of the present invention to provide a perpendicular magnetic recording head in which a side shield can be formed by an easy process, and a manufacturing method for the perpendicular magnetic recording head.

Additional objects and advantages of the invention will be set forth in part in the description which follows, and in part will be apparent from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

The embodiments will be explained with reference to the accompanying drawings.

FIGS. 1A to 1G are cross-sectional views of a perpendicular magnetic recording head according to a first embodiment of the present invention, taken along an air bearing surface.

FIGS. 2A to 2G are top views of the perpendicular magnetic recording head of the first embodiment, as viewed from above in a laminating direction of thin films.

FIGS. 3A to 3G are cross-sectional views of a perpendicular magnetic recording head according to a second embodiment, taken along an air bearing surface.

FIGS. 4A to 4G are top views of the perpendicular magnetic recording head of the second embodiment, as viewed from above in a laminating direction of thin films.

FIG. 5 is a cross-sectional view explaining a thin film magnetic head for perpendicular magnetic recording.

FIG. 6 is an explanatory view showing the planar shape of a magnetic pole in the thin film magnetic head for perpendicular magnetic recording, as viewed from above in a laminating direction.

FIGS. 7A to 7E are explanatory views showing a known method for forming a front end portion of a main magnetic pole.

FIGS. 8A to 8C are explanatory views showing the known method for forming a front end portion of a main magnetic pole.

FIGS. 9A to 9F are cross-sectional views of a known side shield, as viewed from an air bearing surface.

FIGS. 10A to 10F are cross-sectional views of the known side shield, as viewed from the direction perpendicular to an air bearing surface.

### DETAILED DESCRIPTION OF THE PREFERRED EMBODIMENTS

The embodiments will be described in detail below with reference to the accompanying drawings.

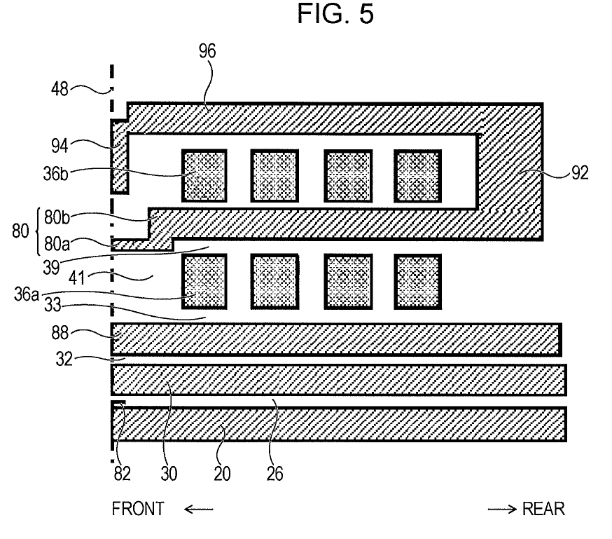

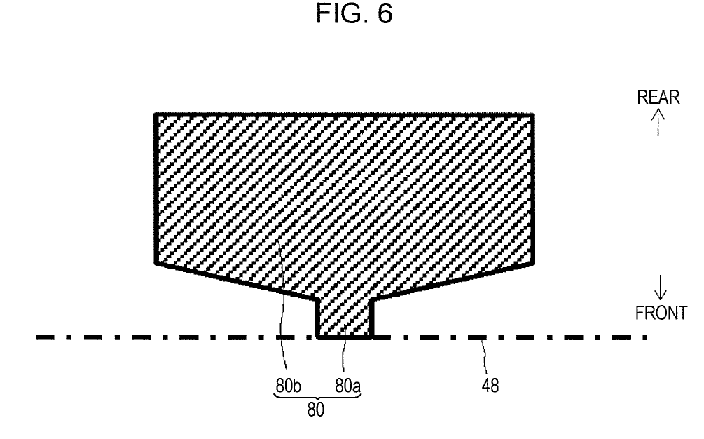

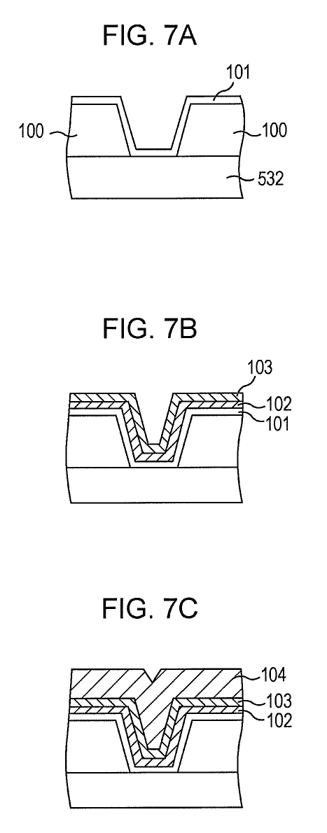

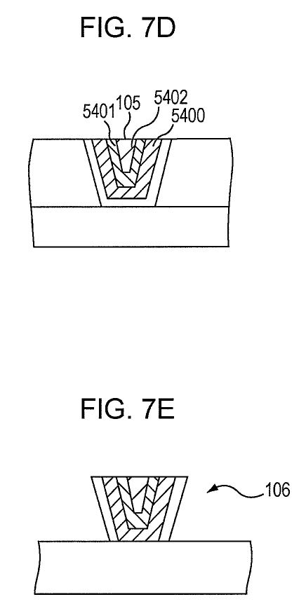

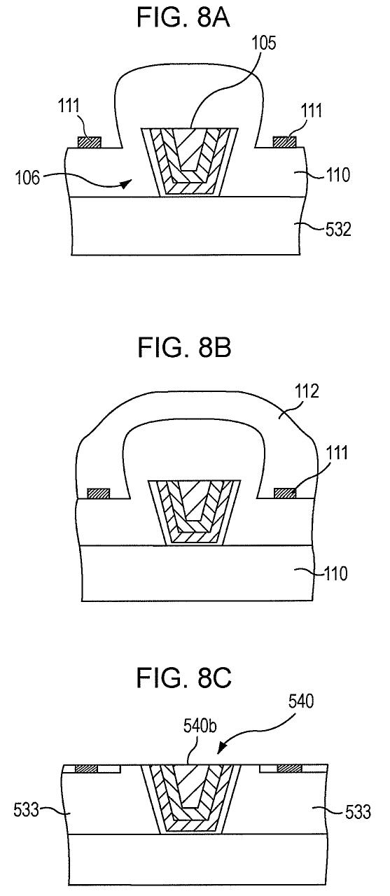

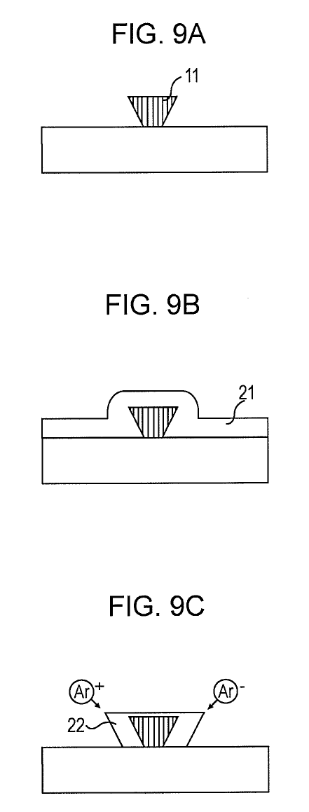

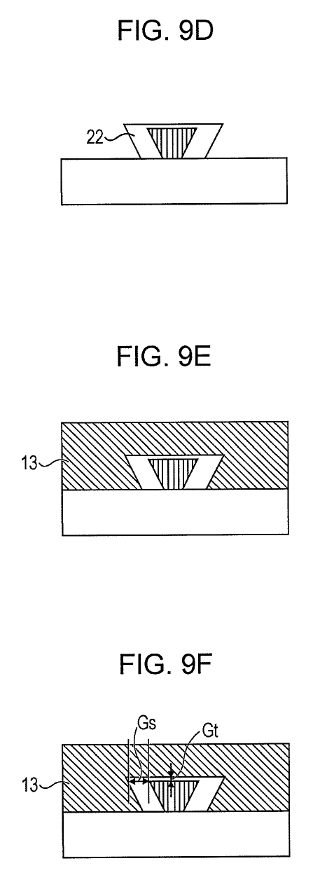

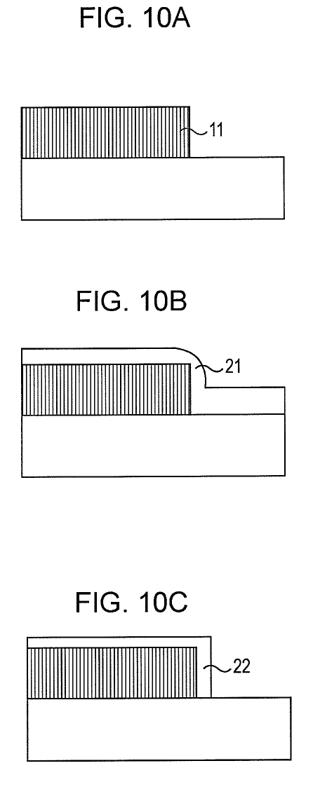

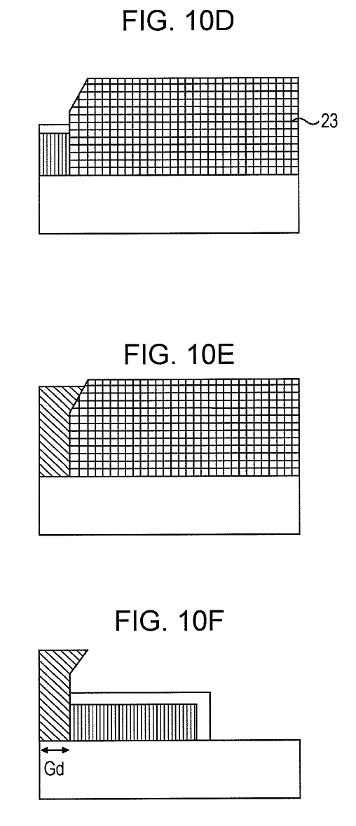

A basic configuration of a thin film magnetic head including a perpendicular magnetic recording head according to an embodiment of the present invention is the same as that of the above-described thin film magnetic head shown in FIG. 5. A manufacturing method for the thin film magnetic head is basically similar to the above-described method described with reference to FIG. 5. The perpendicular magnetic recording head and the manufacturing method therefor according to the embodiment are characterized in structures of a main magnetic pole and a side shield and a manufacturing method therefor. The following description will focus on these characteristics.

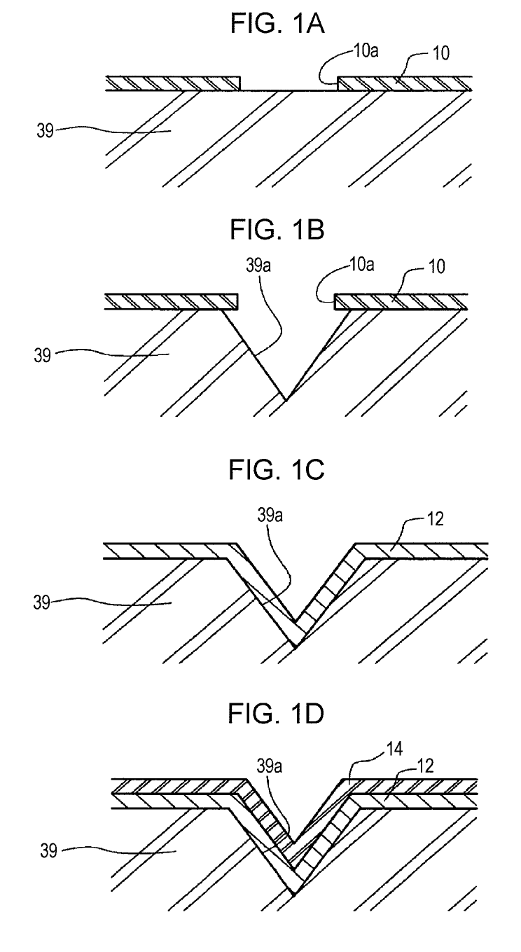

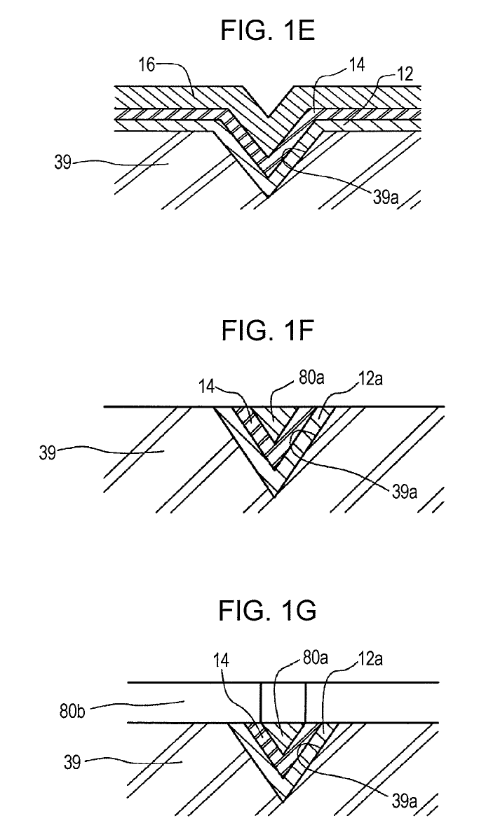

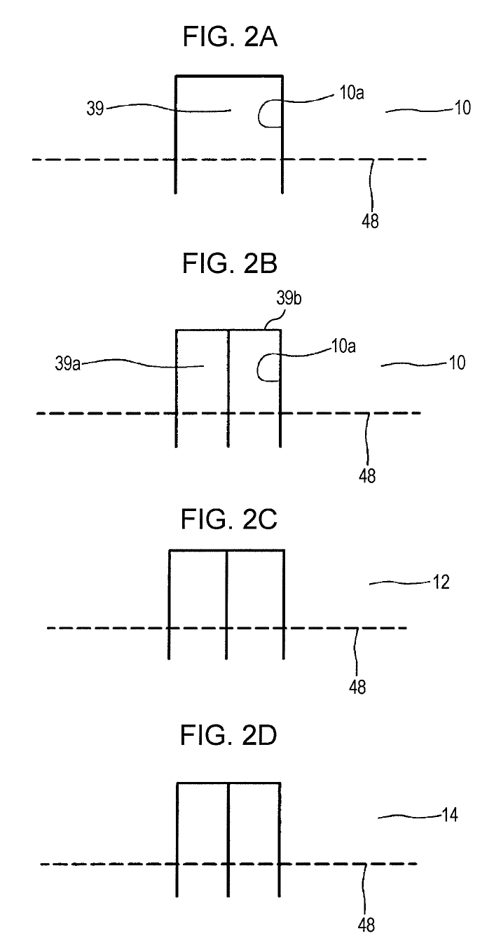

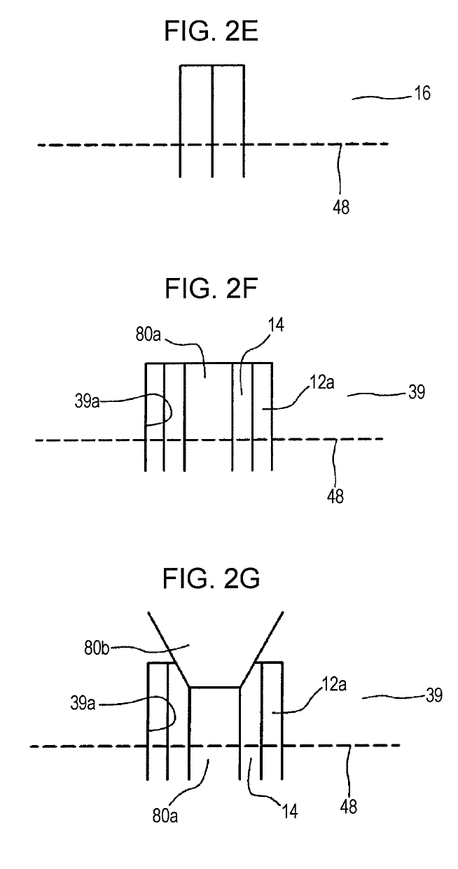

A manufacturing method for a perpendicular magnetic recording head according to a first embodiment will now be described. FIGS. 1A to 1G are cross-sectional views of the perpendicular magnetic recording head at an air bearing surface 48. FIGS. 2A to 2G are top views of the perpendicular magnetic recording head, as viewed from above in a laminating direction of thin films. These figures show a method for forming a main magnetic pole 80 after a first nonmagnetic layer 39 (see FIG. 5) of alumina is formed.

First, as shown in FIGS. 1A and 2A, a hard mask 10 is formed on a first nonmagnetic layer 39 of alumina. A groove 10a is formed in the hard mask 10 by patterning. The groove 10a extends in the front-rear direction orthogonal to the air bearing surface 48 so as to cross the air bearing surface 48. From the groove 10a, the first nonmagnetic layer 39 is exposed.

Subsequently, reactive ion etching (RIE) is performed from above the hard mask 10 so as to etch a portion of the first nonmagnetic layer 39 exposed from the groove 10a of the hard mask 10. A groove 39a extending in the front-rear direction orthogonal to the air bearing surface 48 is thereby formed in the first nonmagnetic layer 39, as shown in FIGS. 1B and 2B. The hard mask 10 is formed of a material having a reactive ion etching rate that is lower than that of the first nonmagnetic layer 39 formed of alumina.

The groove 39a is V-shaped in the cross section along the air bearing surface 48, that is, is defined by inclined inner wall surfaces. Further, the conditions of the hard mask 10 and reactive ion etching are set so that an inner wall surface at a rear end 39b of the groove 39a is a vertical surface substantially parallel to the laminating direction of the thin films.

While the opening width at the top of the groove 39a is not particularly limited, it is set at about 200 to 500 nm, more preferably, at about 360 nm. The depth of the groove 39a is set at about 200 to 500 nm, more preferably, at about 360 nm. After that, the hard mask 10 is removed.

Subsequently, as shown in FIGS. 1C and 2C, a first soft magnetic layer 12 of a soft magnetic material is formed on an upper surface of the first nonmagnetic layer 39 except the groove 39a and on the inner wall surfaces of the groove 39a, for example, by sputtering or vapor deposition. The thickness of the first soft magnetic layer 12 on the inner wall surfaces of the groove 39a is set at about 50 to 110 nm, more preferably, at about 80 nm. The first soft magnetic layer 12 will become a side shield 12a later. As the material of the first soft magnetic layer 12, for example, a nickel-iron alloy can be adopted.

Next, as shown in FIGS. 1D and 2D, a second nonmagnetic layer 14 is formed by a nonmagnetic thin film on a surface of the first soft magnetic layer 12 (on an upper surface except the groove 39a and in the groove 39a), for example, by sputtering or vapor deposition. The thickness of the second nonmagnetic layer 14 in the groove 39a is set at, for example, about 20 to 80 nm, more preferably, at about 50 nm. As the material of the second nonmagnetic layer 14, for example, tantalum can be adopted.

Subsequently, as shown in FIGS. 1E and 2E, a second soft magnetic layer 16 is formed on a surface of the second nonmagnetic layer 14 (on an upper surface outside of the groove 39a and in the groove 39a), for example, by performing electrolytic plating using the first soft magnetic layer 12 and the second nonmagnetic layer 14 as power feed layers. The second soft magnetic layer 16 will become a front end portion 80a of a main magnetic pole 80 later. As the material of the second soft magnetic layer 16, for example, an iron-cobalt alloy can be adopted. The first soft magnetic layer 12 and the second soft magnetic layer 16 are not coupled magnetostatically.

Subsequently, the second soft magnetic layer 16, the second nonmagnetic layer 14, and the first soft magnetic layer 12 are flattened from the upper surface so as to reach the first nonmagnetic layer 39, so that a side shield 12a, the second nonmagnetic layer 14, and a main-magnetic-pole front end portion 80a are provided only in the groove 39a, as shown in FIGS. 1F and 2F.

The side shield 12a is a part of the first soft magnetic layer 12 that is left in the groove 39a after the above-described flattening, and the main-magnetic-pole front end portion 80a is a part of the second soft magnetic layer 16 that is left in the groove 39a after the above-described flattening. By flattening, the width of an upper surface of the main-magnetic-pole front end portion 80a (core width) is set to be 100 nm. Flattening can be performed, for example, by chemical mechanical polishing (CMP).

Preferably, the thickness of the second nonmagnetic layer 14 in the groove 39a is set to be 20 nm or more and more than half the core width of the upper surface of the main-magnetic-pole front end portion 80a (in the first embodiment, half the core width of 100 nm, that is, 50 nm). This maintains a sufficient gap between the main-magnetic-pole front end portion 80a and the side shield 12a, which will be described below, and ensures a sufficient functionality of the side shield 12a without magnetostatically coupling the main-magnetic-pole front end portion 80a and the side shield 12a.

Subsequently, as shown in FIGS. 1G and 2G, a main-magnetic-pole yoke portion 80b is formed on the rear side of the main-magnetic-pole front end portion 80a. The main-magnetic-pole yoke portion 80b is connected to the upper surface at the rear end of the main-magnetic-pole front end portion 80a, and widens toward the rear side. The main-magnetic-pole yoke portion 80b can be formed, for example, by plating using photolithography. As shown in FIG. 2G, the main-magnetic-pole yoke portion 80b is provided at a position such as to be out of contact with the side shield 12a, that is, so as to be magnetically insulated from the side shield 12a.

After that, as shown in FIG. 5, the main magnetic pole 80 (the main-magnetic-pole front end portion 80a and the main-magnetic-pole yoke portion 80b) is covered with a nonmagnetic layer of alumina or the like, and the second coil 36b, the trailing shield 94, and the return yoke 96 are formed on the nonmagnetic layer. These steps are the same as those described as the background art. In FIG. 5, the side shield 12 is not shown.

While the first soft magnetic layer 12 and the second nonmagnetic layer 14 are formed by sputtering or vapor deposition in the above-described first embodiment, they may be formed by electrolytic plating. In this case, after the groove 39a shown in FIGS. 1B and 2B is formed and the hard mask 10 is removed, for example, a titanium layer (not shown) serving as a plating power feed layer is formed on the surface of the first nonmagnetic layer 39 (the upper surface except the groove 39a and in the groove 39a) by sputtering. Subsequently, a first soft magnetic layer 12 (for example, a nickel-iron alloy layer) is formed by electrolytic plating with power supplied to the plating power feed layer. Further, a second nonmagnetic layer 14 (for example, a copper layer) is formed by electrolytic plating with power supplied to the plating power feed layer (titanium layer). By similar power feeding, electrolytic plating of a second soft magnetic layer 16 (an iron-cobalt alloy) can be performed.

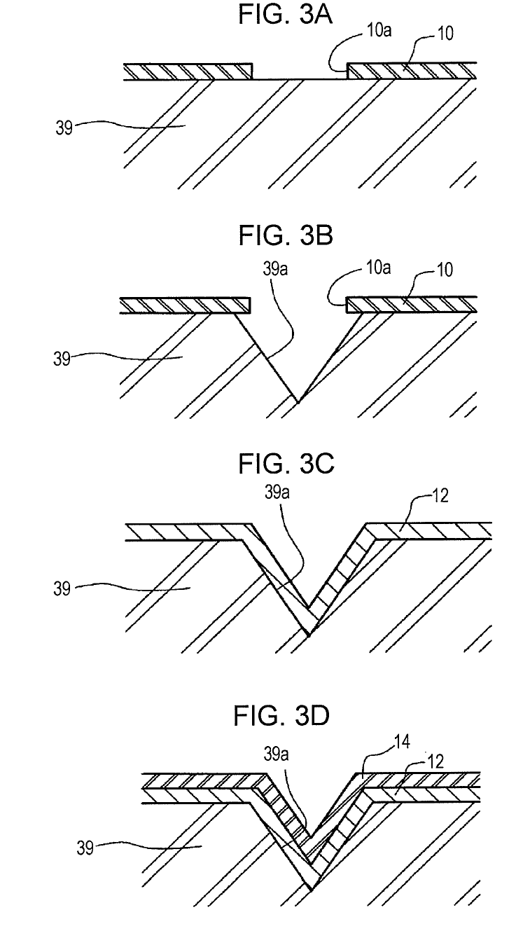

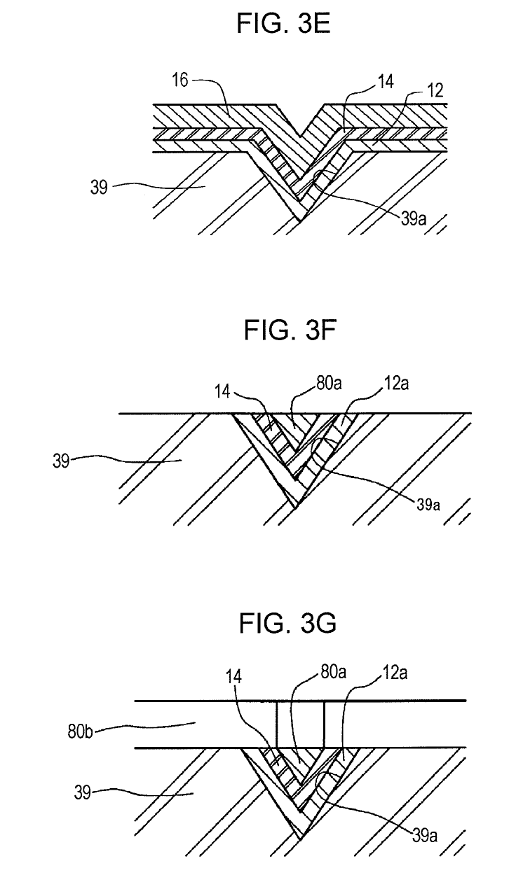

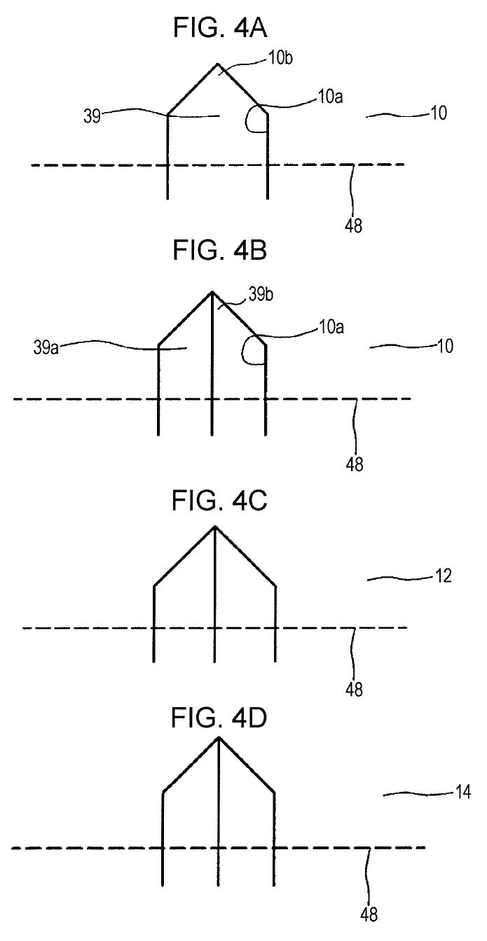

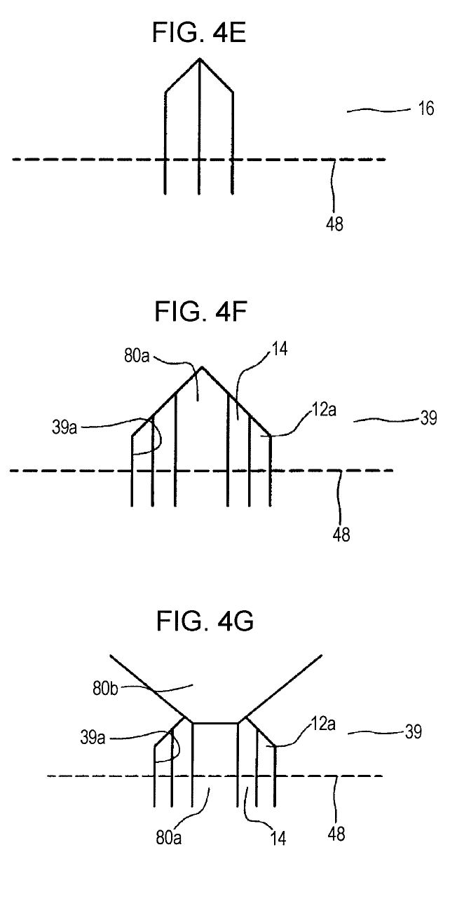

A description will now be given of a perpendicular magnetic recording head and a manufacturing method therefor according to a second embodiment. FIGS. 3A to 3G are cross-sectional views of the perpendicular magnetic recording head, taken along an air bearing surface 48. FIGS. 4A to 4G are top views of the perpendicular magnetic recording head, as viewed from above in the laminating direction of thin films.

In the second embodiment, as shown in FIGS. 3A and 4A, a groove 10a of a hard mask 10 is formed so that the widthwise center of a rear end portion 10b protrudes rearward from both side edges. In other words, the planar shape of the opening at the rear end portion 10b of the groove 10a is sharply pointed in the rearward direction.

Accordingly, a groove 39a of a first nonmagnetic layer 39, corresponding to the groove 10a of the hard mask 10, is formed so that the widthwise center of a rear end portion 39b protrudes rearward from both side edges. In other words, the planar shape of the opening at the rear end portion 39b of the groove 39a is sharply pointed in the rearward direction. Since steps shown in FIGS. 3C to 3G and 4C to 4G can be the same as the steps shown in FIGS. 1C to 1G and 2C to 2G, descriptions thereof are omitted.

By forming the groove 39a, as in the second embodiment, a rear end of the side shield 12a can be formed on the front side of the rear end of the main-magnetic-pole front end portion 80a (closer to the air bearing surface). Therefore, when the main-magnetic-pole yoke portion 80b is formed, as shown in FIG. 4G, it can be reliably connected to the main-magnetic-pole front end portion 80a, and can be reliably magnetically insulated from the side shield 12a while maintaining a sufficient distance therebetween. Further, as shown by comparison of FIG. 2G and FIG. 4G, the angle by which the main-magnetic-pole yoke portion 80b widens toward the rear side can be increased while maintaining insulation between the yoke portion 80b and the side shield 12a.

In the manufacturing method for a perpendicular magnetic recording head and the perpendicular magnetic recording head made by the manufacturing method according to the above-described embodiments, the side shield 12a can be formed near the main-magnetic-pole front end portion 80a by simply forming the first soft magnetic layer 12 in the groove 39a.

Japanese Laid-Open Patent Publication No. 2006-196142 discloses that magnetic layers and nonmagnetic layers are stacked in a groove at the front end of a main magnetic pole. In this case, the magnetic layers separated by the nonmagnetic layers are connected to a rear portion (yoke portion) of the main magnetic pole so as to integrally form the magnetic pole. Moreover, since the nonmagnetic layers between the magnetic layers are considerably thin, the magnetic layers are coupled magnetostatically. This configuration is entirely distinguished in the essential feature and the technical idea from the present invention in which the main magnetic pole and the side shield are completely magnetically insulated from each other and are arranged sufficiently apart from each other so as not to be coupled magnetostatically.

In the perpendicular magnetic recording head and the manufacturing method therefor according to the present invention, it is possible to form a side shield by an easy step.

The order in which the embodiments were described is not a showing of superiority and inferiority relative to each other. Although the embodiments of the present inventions have been described in detail, it should be understood that the various changes, substitutions, and alterations could be made hereto without departing from the spirit and scope of the invention.

What is claimed is:

1. A manufacturing method for a perpendicular magnetic recording head, comprising the steps of:
forming a groove in a first nonmagnetic layer, the groove extending in a front-rear direction orthogonal to an air bearing surface;
forming a side shield on an inner wall of the groove, the side shield being formed of a soft magnetic material;
forming a second nonmagnetic layer on a surface of the side shield in the groove;
forming a main-magnetic-pole front end portion on a surface of the second nonmagnetic layer in the groove, the main-magnetic-pole front end portion being formed of a soft magnetic material that is not magnetostatically coupled to the side shield; and
forming a main-magnetic-pole yoke portion magnetically insulated from the side shield and magnetically connected to the main-magnetic-pole front end portion, the main-magnetic-pole yoke portion widening from the main-magnetic-pole front end portion toward a rear side.

2. The manufacturing method according to claim 1,
wherein a first soft magnetic layer that forms the side shield, the second nonmagnetic layer, and a second soft magnetic layer that forms the main-magnetic-pole front end portion are formed in the groove and on a surface of the first nonmagnetic layer except the groove, and
the second soft magnetic layer, the second nonmagnetic layer, and the first soft magnetic layer are flattened from the top to the first nonmagnetic layer so that the side shield, the second nonmagnetic layer, and the main-magnetic-pole front end portion are provided only in the groove.

3. A perpendicular magnetic recording head, comprising:
a first nonmagnetic layer including a groove extending in a front-rear direction orthogonal to an air bearing surface;
a side shield provided along an inner wall of the groove and formed of a soft magnetic material;
a second nonmagnetic layer provided along an inner wall of the side shield in the groove;
a main-magnetic-pole front end portion provided inside the second nonmagnetic layer in the groove and formed of a soft magnetic material that is not magnetostatically coupled to the side shield; and
a main-magnetic-pole yoke portion magnetically insulated from the side shield and magnetically connected to the main-magnetic-pole front end portion, the main-magnetic-pole yoke portion widening from the main-magnetic-pole front end portion to a rear side.

4. The perpendicular magnetic recording head according to claim 3,
wherein a widthwise center of the groove protrudes rearward from both side edges at a rear end of the groove, and
a rear end of the side shield provided in the groove is disposed on a front side of a rear end of the main-magnetic-pole front end portion.

5. The perpendicular magnetic recording head according to claim 3,
wherein a thickness of the second nonmagnetic layer is 20 nm or more and more than half a core width of an upper surface of the main-magnetic-pole front end portion.

6. The perpendicular magnetic recording head according to claim 4,
wherein a thickness of the second nonmagnetic layer is 20 nm or more and more than half a core width of an upper surface of the main-magnetic-pole front end portion.
